(19) United States
(12) Patent Application Publication
(10) Pub. No.: US 2026/0149939 A1
(43) Pub. Date: May 28, 2026

(54) EAR-WORN HEARING DEVICE WITH IN-EAR SENSOR

(71) Applicant: KNOWLES ELECTRONICS, LLC, ITASCA, IL (US)

(72) Inventor: PAULO NALAGAY DIPUS, SANTA ROSA (PH)

(21) Appl. No.: 18/957,089

(22) Filed: Nov. 22, 2024

(51) Int. Cl. H04R 25/00

(52) U.S. Cl. CPC H04R 25/65

(57) ABSTRACT

A hearing device including a spout configured for wearing on a user's concha or at least partially in a user's ear canal is disclosed. The hearing device includes a speaker having a sound outlet acoustically coupled to an opening of a spout by a speaker sound path, and a sensor having a signal input coupled to the spout opening by a sensor signal path. A partition disposed in the passage of the spout is located between the speaker sound path and the sensor signal path, wherein the partition isolates the sensor signal path from the speaker sound path along at least a portion of the spout passage.

### FIELD OF THE DISCLOSURE

The present disclosure relates generally to ear-worn hearing devices and more particularly to ear-worn hearing devices comprising a speaker and an in-ear sensor, and subassemblies and components for such hearing devices.

### BACKGROUND

Some ear-worn hearing devices comprise a speaker disposed in a housing having a nozzle configured for at least partial insertion in a user's ear canal. One such device is a receiver-in-canal (RIC) hearing aid. Advances in audio signal processing, miniaturization, reductions in power consumption, and lower costs have spurred increasing adoption of active noise cancellation (ANC) and other audio enhancing functionality in ear-worn hearing devices. These audio enhancing features can benefit from an acoustic sensor capable of sensing conditions within the user's ear. As such, a sound path of the speaker can interfere with a sound path of the acoustic sensor. Also, proper integration of these and other components within the hearing device is difficult and improper assembly can result in performance issues and increased costs. Thus, there is an ongoing need for improved ear-worn hearing devices, sub-assemblies, and components therefor.

### BRIEF DESCRIPTION OF THE DRAWINGS

The objects, features and advantages of the present disclosure will become more fully apparent upon consideration of the following detailed description and appended claims in conjunction with the accompanying drawings. The drawings depict only representative embodiments and implementations and are not considered to limit the teachings of the disclosure, the scope of which is set forth by the appended claims.

FIG. 1 is a representative ear-worn hearing device comprising an ear-worn unit connected to a base unit by an electrical cable.

FIG. 2 is an exploded view of a representative ear-worn hearing device.

FIG. 3 is an exploded view of an alternative ear-worn hearing device.

FIG. 4 is a perspective view of a front housing portion of an ear-worn hearing device.

FIG. 5 is a perspective view of an acoustic sensor integrated with the front housing portion of FIG. 4.

FIG. 6 is a perspective view of a speaker integrated with the front housing portion of FIG. 5.

FIG. 7 is a perspective view of a rear housing portion of an ear-worn hearing device.

FIG. 8 is a perspective view of an acoustic sensor integrated with the rear housing portion of FIG. 7.

FIG. 9 is a sectional view of a representative ear-worn hearing device.

FIG. 10 is a sectional view of a representative sensor.

FIG. 11 is a sectional view of a balanced armature receiver.

Those of ordinary skill in the art will appreciate that the drawings are illustrated for simplicity and clarity and therefore may not be drawn to scale and may not include well-known features, that the order of occurrence of actions or steps may be different than the order described, that some or all of such actions or steps may be performed concurrently unless specified otherwise, and that the terms and expressions used herein have meaning understood by those of ordinary skill in the art except where a different meaning is specifically attributed to them.

### DETAILED DESCRIPTION

The disclosure relates generally to ear-worn hearing devices comprising a speaker and an in-ear sensor, hearing device subassemblies, and components for hearing devices. Such hearing devices include, but are not limited to, receiver-in-canal (RIC) devices, in-the-ear (ITE) devices, in-the-canal (ITC) devices, and true wireless stereo (TWS) devices, among other earphones and hearing devices worn on a user's concha or at least partially in the user's ear canal. Representative implementations are described herein.

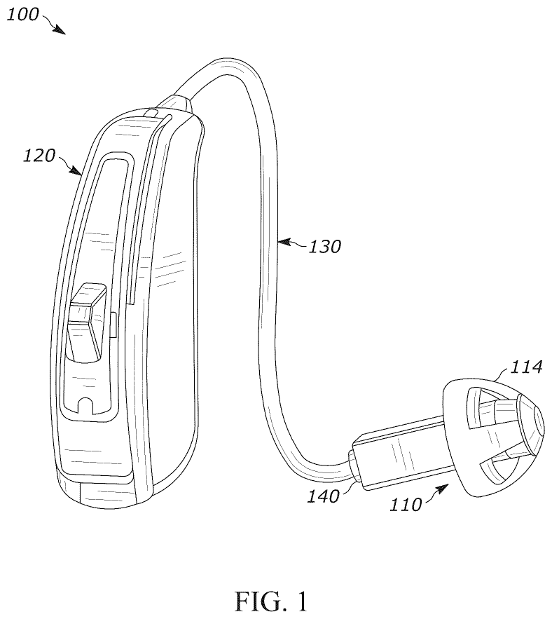

FIG. 1 is a representative ear-worn hearing device 100 comprising an ear-worn unit 110 connected to a base unit 120 by an electrical cable 130. The electrical cable comprises a first end portion connected to an interface 140 of the ear-worn unit and a second end portion comprises a connector releasably or permanently connected to the base unit. The first end portion of the electrical cable is electrically connected to one or more electrical components (e.g., speaker or sensor) of the ear-worn unit, and the second end portion of the electrical cable is electrically connected, or connectable, to electrical components (e.g., processor or other electrical circuits) of the base unit. An ear-worn unit alone or in combination with the electrical cable 130 is also referred to herein as a “receiver-in-canal (RIC) unit” or a “speaker component”. A resilient ear dome 114 can be connected to a ribbed spout to support the ear-worn unit at least partially in a user's ear canal. The ear-worn unit generally comprises one or more speakers that generate sound in response to an electrical audio signal provided by the base unit, described further herein.

The representative base unit 120, also referred to herein as a behind-the-ear (BTE) unit or component, is configured for wearing on a back side of the user's ear. Alternatively, the base unit can be configured for wear on or around some other body portion, e.g., the head, neck, or arm, among other body parts. The base unit generally comprises a processor and other circuits, one or more microphones, and a battery. The base unit can also comprise a wireless transceiver among other circuits and components. Thus configured, the base unit can detect acoustic signals and generate and process (e.g., suppress noise, amplify sound, etc.) electrical audio signals produced by the one or more microphones in response to detecting the acoustic signals. The electrical audio signals are transmitted to the ear-worn unit 110 via the electrical cable 130.

In other ear-worn hearing devices, the components and functionality of the ear-worn unit and base unit described herein are integrated in a unitary ear-worn hearing device. Such hearing devices can be implemented as ITE, ITC, and TWS devices, among other earphones and devices configured for wearing on the concha or at least partially in a user's ear canal. These and other ear-worn hearing devices may or may not include a resilient ear dome. More generally, the configuration of the ear-worn hearing device and configuration of speakers, microphones or other sensors therein depends on whether the device is configured for wearing on the concha, partially in, or more fully in the user's ear canal.

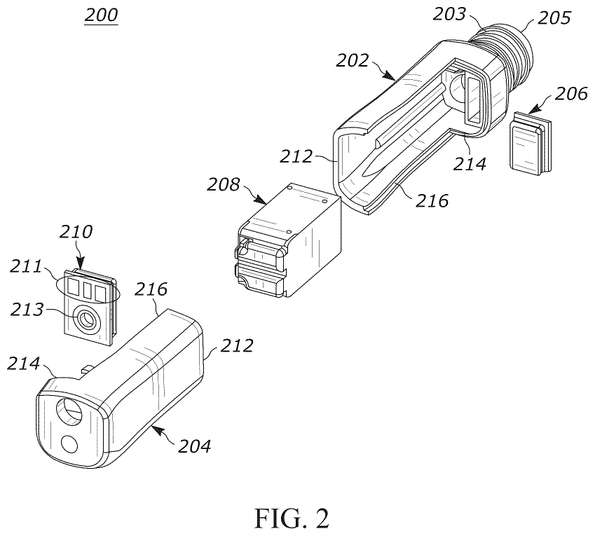

The one or more speakers are at least partially disposed in a housing of the hearing device comprising a spout configured for wearing on the user's concha or at least partially in the user's ear canal. In FIGS. 1-3 and 9, the speaker is fully encapsulated by the housing. In other implementations, an exposed portion of the speaker housing can be an exterior of the hearing device. In any case, a sound outlet of the one or more speakers is acoustically coupled to an opening of the spout by a speaker sound path extending through a passage of the spout. In FIGS. 2, 3 and 9, a representative ear-worn hearing device 200 comprises a receiver 208 disposed in a hearing device housing having a spout 203 configured for at least partial insertion in the user's ear canal. The spout can comprise a flatter lobe or other shaped portion that faces the user's ear for hearing devices configured for wearing on the concha. In any case, the spout comprises a passage 205 terminating at an opening 207 of the spout.

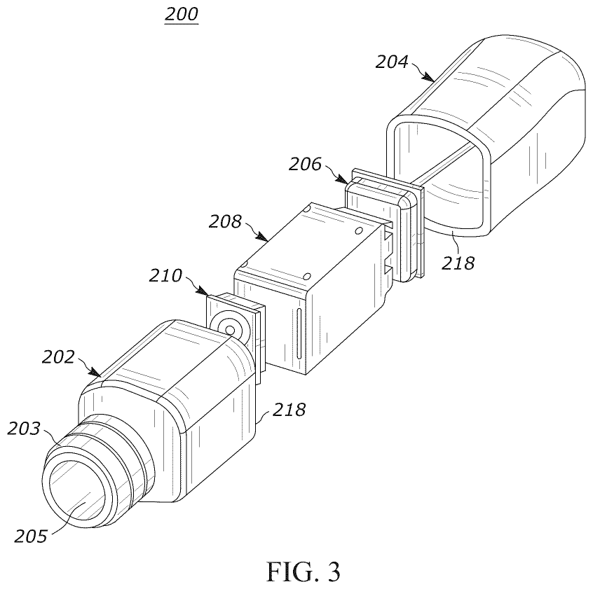

FIGS. 2 and 3 are exploded views of representative hearing device assemblies 200 each generally comprising a front housing portion 202 and a rear housing portion 204. The front and rear housing portions have complementary shapes that can be assembled and retained with snap-fitting features and/or glue. The front and rear housing portions are generally configured to provide preassembly access to interior portions thereof for installation of components prior to fastening the housing portions together. The front housing portion 202 is configured to enable installation of a sensor 206 and one or more speakers 208 therein prior to assembly with the rear housing portion. The rear housing portion 204 is configured to enable installation of an optional sensor 210 and other components, depending on the nature and requirements of the hearing device, prior to assembly with the front housing portion. In FIG. 2, each housing portion comprises open ends 212 and 214 offset by an open side 216 that mates with complementary ends and a side of the other housing portion upon assembly. In FIG. 3, each housing portion comprises an open end 218 that mates with a complementary open end of the other housing portion upon assembly. In other implementations, the housings can comprise more than two housing portions that can be assembled after installation of components therein. Thus configured, assembly of the speaker, sensor, and other internal components of the hearing device can be performed more simply, accurately and efficiently, with fewer errors and reduced cost.

The housing comprises a speaker sound path acoustically coupling a sound outlet of the speaker to the opening of the spout. The housing also comprises a sensor signal path coupling an input of the sensor to the opening of the spout. A partition isolates the sensor signal path from the speaker sound path along at least a portion of the spout passage to reduce undesirable feedback and other adverse effects resulting from mixing of the sensor signal and the speaker signal.

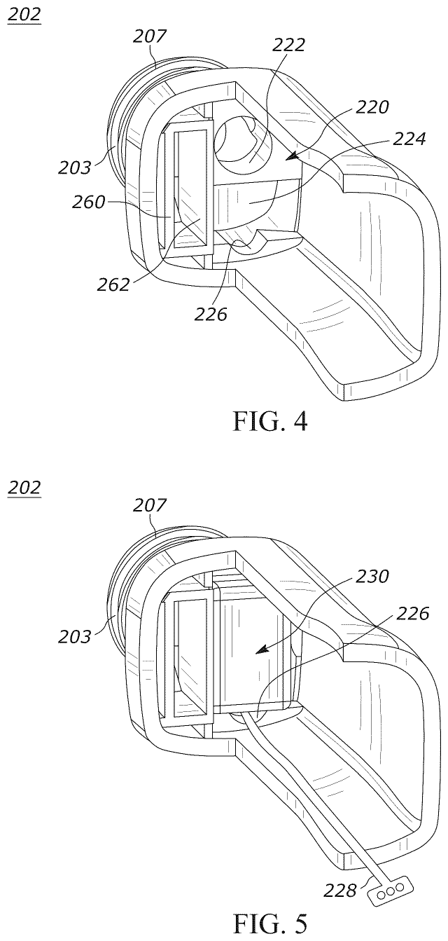

In FIG. 4, a representative front housing portion 202 comprises a sensor mounting surface 220 at an interior of the housing proximate the spout 203. The sensor signal path extends through an opening 222 of the sensor mounting surface 220 and through the passage to the spout opening 207, best shown in FIG. 9. The configuration of the front housing portion provides ready access to the sensor mounting surface to facilitate integration of a sensor with the front housing portion prior to assembly of the front housing portion with the rear housing portion.

In FIG. 5, a sensor 230 is mounted on the sensor mounting surface 220. In FIG. 9, an input of the sensor 230 is positioned over the opening 222 of the sensor mounting surface 220 for detecting conditions in the user's ear. The sensor can be fastened to the sensor mounting surface with glue or other fastening mechanism to provide an airtight seal and fix the position of the sensor prior to assembly of the housing portions.

In FIGS. 4 and 9, the front housing portion 202 also comprises a recess 224 adjacent to the sensor mounting surface 220. The recess 224 provides space for a flex circuit or other conductors electrically connected to an external electrical interface of a sensor mounted on the sensor mounting surface. The recess also accommodates any slack in the electrical conductor. The recess includes a conductor routing portion 226 for routing the conductor to another part of the housing, shown best in FIG. 4. In FIG. 9, the sensor 230 comprises an external electrical interface on a surface 232 facing the recess 224 adjacent to the sensor mounting surface 220. In FIG. 2, the sensor 210 comprises an external electrical interface 211 adjacent a sensor input 213. Sensor 206 can also include an electrical interface and sensor input. In FIG. 5, a flex circuit 228 connected to the external electrical interface of the sensor 230 extends through the recess and through the conductor routing portion 226 toward a rear portion of the housing. Alternatively, litz wires or other conductors can be used in lieu of the flex circuit.

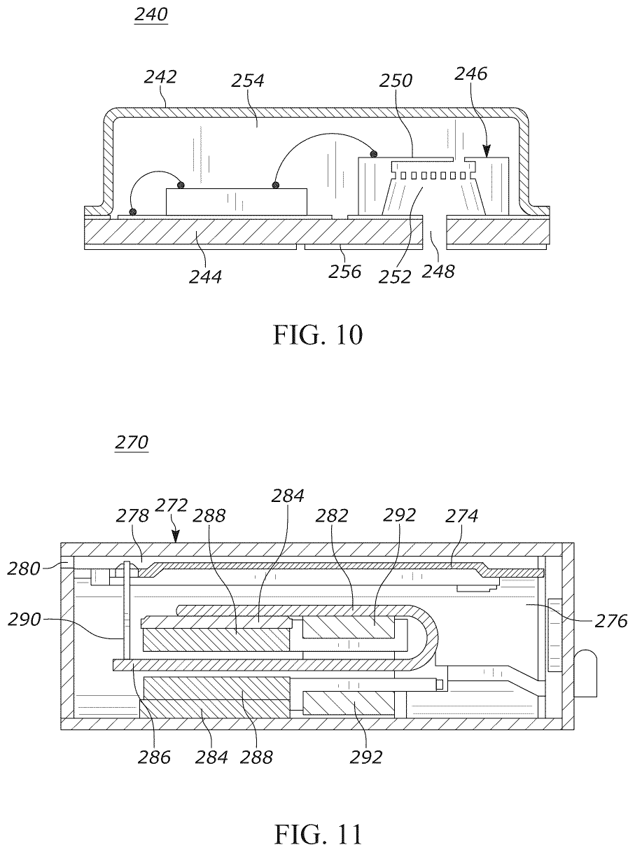

The sensor can be a microphone, vibration sensor, or physiological sensor among others. In FIG. 10, a representative microphone 240 comprises a sensor housing including a cover 242 mounted on a base 244. A transducer 246 disposed in the housing is mounted on the base over a sound port 248. The representative transducer is a capacitive device comprising a diaphragm 250 movable relative to a fixed backplate 252. Alternatively, the transducer can be a piezoelectric or other transduction device. These and other transducers can be microelectromechanical (MEMS) devices. An electrical circuit 254 also disposed in the sensor housing is electrically connected to the transducer 246 and to an external electrical interface 256 on an external surface of the base. A portion of the sensor base including the sound port 248 is mounted on the sensor mounting surface 220 of FIG. 4. The external electrical interface 256 of the sensor is located on the portion of the sensor base facing the recess 224 adjacent to the sensor mounting surface as described herein.

In FIG. 4, the front housing portion 202 also comprises a speaker mounting surface 260 located at an interior of the housing proximate the spout 203. The speaker mounting surface 260 stands proud of the sensor mounting surface 220 to provide space for the sensor adjacent a speaker mounted on the speaker mounting surface. The speaker sound path extends through an opening 262 of the speaker mounting surface 260 and through the passage of the spout. The partition between the speaker sound path and the sensor signal path comprises a wall portion separating the speaker sound path from the sensor signal path. Such a wall portion can extend from the mounting sensor surface or the speaker mounting to the opening of the spout. The configuration of the front housing portion provides ready access to the speaker mounting surface to facilitate integration of a speaker with the front housing portion prior to assembly of the front housing portion with the rear housing portion.

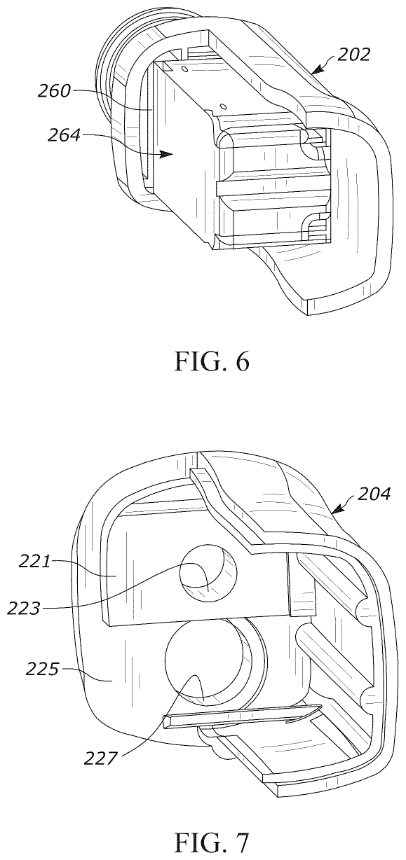

In FIG. 6, a speaker 264 is mounted on the speaker mounting surface 260 after mounting the sensor. The speaker can be fastened to the speaker mounting surface with glue or other retention mechanism to provide an airtight seal and fix the position of the speaker prior to assembly of the housing portions. In FIG. 6, the speaker 264 is mounted on the speaker mounting surface 260 adjacent to a sensor mounted on the sensor mounting surface. The sensor is located between the speaker and the spout opening. FIG. 9 shows the speaker 264 offset relative to the sensor 230 due to the recessed location of the sensor mounting surface. The speaker mounting surface is not shown in the sectional view of FIG. 9.

In some implementations, the sensor can be retained against the sensor mounting surface by appropriate positioning of the speaker, alone or in combination with resilient material, with or without glue. A sound outlet on an end of the speaker faces the opening 262 of the speaker mounting surface 260. An opposite end of the speaker comprises an external electrical interface 266 connectable to a terminal or other circuits of the hearing device. In other implementations, two or more speakers arranged in a stack can be mounted on the speaker mounting surface so that the sound outlets of both speakers face the opening of the speaker mounting surface.

The one or more speakers can be balanced armature receivers (also referred to herein as “receivers”) or dynamic speakers, or a combination thereof. In FIG. 11, a representative balanced armature receiver 270 comprises a housing 272 containing a diaphragm 274 that separates an interior of the housing into a back volume 276 containing a motor and a front volume 278 having a sound outlet 280. The motor comprises an armature 282 having a first end connected to a yoke 284. The armature includes a second end 286 movably located between magnets retained by the yoke. The movable portion of the armature is connected to the diaphragm by a link 290. An electrical coil 292 disposed about the armature is connected to an electrical terminal 294 on an exterior of the housing. The diaphragm is driven by deflection of the armature between the magnets in response to an electrical audio signal applied to the coil. Other balanced armature receivers suitable for the ear-worn hearing device described herein comprise a variety of alternative architectures. In dynamic speakers (also known as moving coil speakers), the coil is coupled to, and moves, with the diaphragm. Receivers have relatively small size and efficiency making them particularly suitable for use in hearing devices configured for wearing in or partially in the user's ear canal (e.g., RIC units). Hearing devices configured for wear on the concha generally have more space to accommodate multiple receivers and dynamic speakers.

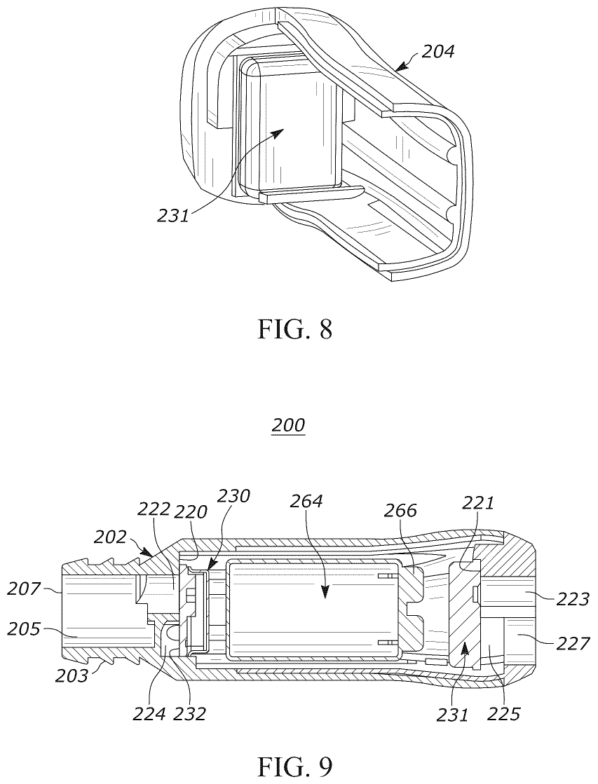

Some ear-worn hearing devices comprise multiple sensors or an electrical cable interface. In FIG. 7, the rear housing portion 204 provides pre-assembly access to a second sensor mounting surface 221 located at an interior of the housing proximate an end portion of the housing opposite the spout. A second sensor signal path comprises an opening 223 through the sensor mounting surface 221 to an exterior of the housing. In FIG. 8, a second sensor 231 is mounted on the sensor mounting surface 220. In FIG. 9, an input (e.g., sound port) of the second sensor 231 faces the opening 223 of the sensor mounting surface 221 as described herein in connection with the sensor 230. In one implementation, the second sensor is a microphone for detecting ambient sounds outside the user's ear. In other implementations, the sensor does not require a port outside the rear portion of the housing. In either case, the sensor can be fastened to the mounting surface with a glue or some other retention mechanism to fix the position of the sensor prior to assembly of the housing portions.

The rear housing portion 204 also comprises a recess 225 adjacent to the second sensor mounting surface 221. The recess 225 accommodates an electrical conductor, examples of which are described herein, electrically connected to an external electrical interface of the second sensor mounted on the second sensor mounting surface, as described herein in connection with the first housing portion. The recess also permits routing the conductor to another part of the housing. A representative acoustic sensor comprising an external electrical interface is described herein with reference to FIG. 10.

The front housing portion including the sensor mounting surface and the speaker mounting surface can be a unitary member. Similarly, the rear housing portion including any rear sensor mounting surface can be a unitary member. Such unitary members can be molded polymers or cast metals, among other materials. Alternatively, one or both of the first and second housing portions can comprise two or more housing portions.

Ear-worn hearing devices comprising an in-ear acoustic sensor can provide enhanced audio performance. An in-ear microphone can be used alone or in combination with another microphone or sensor to detect ambient sound and to improve noise and reduce occlusion. The in-ear microphone can also be used as a probe to obtain real-ear-to-coupler difference (RECD) measurements for customized hearing device fitting, among other uses. An in-ear vibration sensor can be used to detect speech from the user of the hearing device. Such speech detection can be used for ANC and other audio enhancement features.

In one implementation, the ear-worn hearing device is a receiver-in-canal (RIC) hearing device comprising an electrical cable connected to an end portion of the housing opposite the spout, as described in connection with FIG. 1. In RIC and other hearing devices that require an electrical cable, the housing comprises a receptacle for the electrical cable. In FIG. 7, the rear housing portion 204 comprises an aperture 227 through which an end portion of the electrical cable extends. The electrical cable generally comprises one or more conductors electrically interconnecting the sensor, speaker, and other electrical components in the ear-worn unit to a connector connectable to the base unit. In other implementations, the ear-worn hearing device does not include an electrical cable and thus the cable receptacle is not required.

While the disclosure and what is presently considered to be the best mode thereof has been described in a manner establishing possession and enabling those of ordinary skill in the art to make and use the same, it will be understood and appreciated that there are many equivalents to the representative embodiments described herein and that myriad modifications and variations may be made thereto without departing from the scope and spirit of the invention, which is to be limited not by the embodiments described, but by the appended claims and their equivalents.

What is Claimed is:

1. An ear-worn hearing device comprising:
a housing comprising a spout configured for wearing on a user's concha or at least partially in a user's ear canal, the spout comprising a passage extending to an opening of the spout,
a speaker disposed in the housing and comprising a sound outlet acoustically coupled to the opening of the spout by a speaker sound path;
a sensor disposed in the housing and comprising an input coupled to the opening of the spout by a sensor signal path;
a partition disposed in the passage of the spout and located between the speaker sound path and the sensor signal path,
wherein the partition isolates the sensor signal path from the speaker sound path along at least a portion of the passage of the spout.

2. The ear-worn hearing device of claim 1, wherein the partition extends to the opening of the spout.

3. The ear-worn hearing device of claim 1 further comprising a sensor mounting surface located at an interior of the housing proximate the spout, the sensor signal path extending through an opening of the sensor mounting surface, the sensor mounted on the sensor mounting surface with the sensor input facing the opening of the sensor mounting surface.

4. The ear-worn hearing device of claim 3, wherein the sensor comprises an external electrical interface facing a recess of the housing adjacent to the sensor mounting surface, wherein the recess accommodates an electrical conductor electrically connected to the external electrical interface of the sensor.

5. The ear-worn hearing device of claim 3, further comprising a speaker mounting surface located at the interior of the housing proximate the spout, the speaker sound path extending through an opening of the speaker mounting surface, the speaker mounted on the speaker mounting surface with the sound outlet facing the opening of the speaker mounting surface.

6. The ear-worn hearing device of claim 5, wherein the housing is an assembly comprising:
a front housing portion providing pre-assembly access to the sensor mounting surface and pre-assembly access to the speaker mounting surface; and
a rear housing portion connected to the front housing portion.

7. The ear-worn hearing device of claim 4, wherein the sensor comprises:
a sensor housing;
a microelectromechanical systems (MEMS) transducer disposed in the sensor housing; and
an electrical circuit disposed in the sensor housing and electrically connected to the MEMS transducer and to the external electrical interface.

8. The ear-worn hearing device of claim 1 further comprising an acoustic sensor disposed in the housing and comprising a sound port acoustically coupled to an exterior of the housing via an opening through a portion of the housing opposite the spout, wherein the speaker is located between the sensor and the acoustic sensor.

9. An ear-worn hearing device comprising:
a housing comprising a spout for wearing on a user's concha or at least partially in a user's ear canal, the spout comprising a passage extending to an opening of the spout,
a speaker disposed in the housing and comprising a sound outlet acoustically coupled to the opening of the spout by a speaker sound path;
a microphone disposed in the housing and comprising a sound port acoustically coupled to the opening of the spout by a microphone sound path;
a partition disposed in the passage of the spout and separating the speaker sound path from the microphone sound path along at least a portion of the passage,
wherein the partition acoustically isolates the speaker sound path from the microphone sound path.

10. The ear-worn hearing device of claim 9, wherein the partition extends to the opening of the spout.

11. The ear-worn hearing device of claim 10 further comprising:
a microphone mounting surface located on an interior of the housing proximate the spout, the microphone sound path extending through an opening of the microphone mounting surface to the opening of the spout, the microphone mounted on the microphone mounting surface with the sound port of the microphone over the opening of the microphone mounting surface;
a speaker mounting surface located on the interior of the housing proximate the spout, the speaker sound path extending through an opening of the speaker mounting surface to the opening of the spout, the speaker mounted on the speaker mounting surface with the sound outlet of the speaker facing the opening of the speaker mounting surface,
wherein the speaker mounting surface is adjacent to the microphone mounting surface.

12. The ear-worn hearing device of claim 11, wherein the housing is an assembly comprising a front housing portion providing pre-assembly access to the microphone mounting surface and to the speaker mounting surface, and a rear housing portion assembled with the front housing portion.

13. The ear-worn hearing device of claim 12 further comprising a rear microphone mounted on a rear microphone mounting surface of the rear housing portion, the rear microphone comprising a sound port acoustically coupled to an exterior of the housing via an opening through the rear housing portion, wherein the rear housing portion provides pre-assembly access to the rear microphone mounting surface.

14. The ear-worn hearing device of claim 11, wherein the microphone comprises an external electrical interface facing a recess adjacent to the microphone mounting surface, wherein the recess accommodates an electrical conductor electrically connected to the external electrical interface of the microphone.

15. The ear-worn hearing device of claim 14, wherein the microphone comprises:
a microphone housing comprising a cover mounted on a base, the sound port located on a portion of the base mounted on the microphone mounting surface, and the external electrical interface located on a portion of the base facing the recess adjacent to the microphone mounting surface;
a microelectromechanical systems (MEMS) transducer disposed in the microphone housing and mounted over the sound port; and
an electrical circuit disposed in the microphone housing and electrically connected to the MEMS transducer and to the external electrical interface.

16. An ear-worn receiver-in-canal (RIC) hearing device comprising:
a housing comprising a spout configured for at least partial insertion in a user's ear canal, the spout comprising a passage extending to an opening of the spout;
an electrical cable connected to the housing opposite the spout and electrically connected to an electrical component in the housing;
a speaker disposed in the housing and comprising a sound outlet acoustically coupled to the opening of the spout by a speaker sound path extending through the passage of the spout;
a microphone disposed in the housing between the speaker and the opening of the spout, the microphone comprising a sound port acoustically coupled to the opening of the spout by a microphone sound path extending through the passage of the spout;
a partition disposed in the passage of the spout and separating the speaker sound path from the microphone sound path along at least a portion of the passage,
wherein the partition acoustically isolates the speaker sound path from the microphone sound path.

17. The ear-worn RIC hearing device of claim 16 further comprising:
a microphone mounting surface in the housing proximate the spout, the microphone sound path extending through an opening of the microphone mounting surface, the microphone mounted on the microphone mounting surface with the sound port of the microphone over the opening of the microphone mounting surface;
a speaker mounting surface in the housing, the speaker sound path extending through an opening of the speaker mounting surface, the speaker mounted on the speaker mounting surface with the sound outlet of the speaker emanating toward the opening through the speaker mounting surface.

18. The ear-worn hearing device of claim 17, wherein the microphone comprises an external electrical interface facing a recess adjacent to the microphone mounting surface, wherein the recess accommodates an electrical conductor electrically connected to the external electrical interface of the front microphone.

19. The ear-worn hearing device of claim 18, wherein the housing is an assembly comprising:
a unitary front housing portion comprising the microphone mounting surface and the speaker mounting surface, the front housing portion providing pre-assembly access to the microphone mounting surface and to the speaker mounting surface; and
a rear housing portion assembled with the front housing portion.

20. The ear-worn RIC hearing device of claim 19 further comprising a rear microphone mounted on a rear microphone mounting surface of the rear housing portion, a sound port of the rear microphone acoustically coupled to an exterior of the housing via an opening through the rear housing portion, wherein the speaker is located between the microphone and the rear microphone.
